(19) United States
(12) Patent Application Publication
(10) Pub. No.: US 2019/0347678 A1
(43) Pub. Date: Nov. 14, 2019

(54) DYNAMIC ENGAGEMENT ORCHESTRATION SYSTEM AND METHOD TO IMPROVE CUSTOMER EXPERIENCE

(71) Applicant: BELLOMY RESEARCH, INC., Winston-Salem, NC (US)

(72) Inventors: ANTHONY EGGERS, WINSTON-SALEM, NC (US); MATT GULLETT, WINSTON-SALEM, NC (US)

(21) Appl. No.: 16/409,349

(22) Filed: May 10, 2019

Related U.S. Application Data
(60) Provisional application No. 62/670,285, filed on May 11, 2018.

(51) Int. Cl. G06Q 30/02

(52) U.S. Cl. CPC G06Q 30/0203

(57) ABSTRACT

Systems and methods for engagement orchestration that is suited to utilize probabilistic determinations based on collected customer data throughout a complex customer experience ecosystem. Such systems and methods may inform strategic business investment and improve overall customer experience. The engagement orchestration system may dynamically collect customer data through multiple channels across a complex client experience ecosystem. Such systems and methods may be realized through an engagement orchestration engine to facilitate the overall optimization of the engagement orchestration while data analysis, processing, and reporting may be performed by an analysis engine. These functional computing blocks (e.g., engines) may be part of an engagement orchestration provider (EOP) computing platform. As such, the EOP computing platform may also be configured to integrate with third party platforms via a computing network (e.g., an intranet or the Internet) used by a subject organization to effectively collect data and deploy engagement instruments.

### CLAIM TO PRIORITY APPLICATION

This application claims the priority benefit of U.S. Provisional Application No. 62/670,285, entitled “DYNAMIC ENGAGEMENT ORCHESTRATION SYSTEM AND METHOD TO IMPROVE CUSTOMER EXPERIENCE,” filed May 11, 2018, which is incorporated by reference in its entirety herein for all purposes.

### BACKGROUND

The subject matter described herein relates to a dynamic engagement orchestration system and method for enhancing customer experience management and more accurately directing frontline and strategic investment into business processes to improve overall customer experience. Customer experience may be defined as a customer's perceptions about a service resulting from interactions with the service and service provider during the customer life cycle. As used herein, customer experience management comprises “the practice of designing and reacting to customer interactions to meet or exceed customer expectations and thus, increase customer satisfaction, loyalty and advocacy.”

Most organizations contain customer experience ecosystems which are complex sets of relationships among an organization's employees, partners, and customers that determine the quality of customer interactions. At each touchpoint in a journey, customers interact with employees and company partners directly or through technology, such as a website or a printed voice. The actions of all these players determine the nature of the interactions at each and every touchpoint. Customer experience ecosystems are frequently dynamic: when one thing changes, there are often consequences somewhere else. As employees and partners make decisions and take actions on a daily basis, they continually shift the characteristics of customer interactions.

In order for organizations to better manage customer experience the timely delivery of engagement instruments to customers must be carefully orchestrated and contextualized. For this to happen, comprehensive research and data collection must be carried out to gain valuable feedback and insights into the customer's experience at touchpoints across the ecosystem. Organizations frequently engage partners to manage customer experience programs, and to process, consolidate, analyze, and repackage the data from the program, in order to provide the information to the organization in a form that is useful. Businesses can then use that information to inform business performance, actions, and strategies. Various tools and instruments exist; however, most customer experience platforms available today tend to focus on one instrument or they deploy one instrument at a time from a collection of instruments.

What is needed is a comprehensive, dynamic engagement orchestration system that can embed within an organization's existing customer experience ecosystem, that can integrate with other involved organization partners, that is capable of dynamically selecting, based on predetermined engagement criteria and contextual information, the appropriate engagement instrument to be deployed for customer engagement, and that can deploy the engagement instrument in near real time to the proper channel for customer engagement and data collection. The engagement instrument might also store the data collected as well as consolidate, organize, analyze and repackage the data into a format that is useful to the organization.

### BRIEF DESCRIPTION OF THE DRAWINGS

The subject matter presented herein will now be described, by way of example, with reference to the accompanying drawings, in which:

FIG. 1 is a block diagram of a computing environment for realizing the systems and methods of a dynamic engagement orchestration platform that may be used to improve customer experience according to an embodiment of the subject matter disclosed herein;

FIG. 2 is a diagram of data flow in the integrated engagement orchestration system of FIG. 1 illustrating the architecture and flow of data through a subject organization's customer experience ecosystem according to an embodiment of the subject matter disclosed herein;

FIG. 3 is another diagram depicting customer interaction, sampling agent engagement, and data collection via channels (e.g., IVR, agent call, web chat, e-mail, SMS), system components, and integration with the subject organization and third-party technology within the integrated engagement orchestration system of FIG. 1 according to an embodiment of the subject matter disclosed herein;

FIG. 4 is a screenshot illustrating an example implementation of the engagement orchestration system of FIG. 1 illustrating how sites may be set up, added, enabled or disabled according to an embodiment of the subject matter disclosed herein;

FIG. 5 is a flow chart illustrating exemplary computer-based method for dynamic selection of engagement instruments to be presented to users according to an embodiment of the subject matter disclosed herein;

FIG. 6 is a set of exemplary closed loop case management user interfaces and an exemplary workflow intended for subject organization, and other relevant stakeholders according to an embodiment of the subject matter disclosed herein;

FIG. 7 is a diagram illustrating an exemplary customer experience ecosystem and how the platform operates at facets within the ecosystem according to an embodiment of the subject matter disclosed herein;

FIG. 8 is a diagram illustrating customer experience facets within a customer experience ecosystem and how orchestration is applied at the facet level according to an embodiment of the subject matter disclosed herein; and

FIG. 9 is a diagram illustrating deployment of sampling agents within all or substantially all facets across the subject organization's ecosystem for the purpose of engagement orchestration according to an embodiment of the subject matter disclosed herein.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

At the outset, it should be clearly understood that like reference numerals are intended to identify the same structural elements, portions, or surfaces consistently throughout the several drawing figures, as may be further described or explained by the entire written specification of which this detailed description is an integral part. The drawings are intended to be read together with the specification and are to be construed as a portion of the entire “written description” as required by 35 U.S.C. § 112.

### Definitions

For the purposes of the present application, the following definitions shall apply.

A “computing unit” or “computing block” shall refer to software in combination with hardware (such as a processor) and/or firmware for implementing features described herein.

A “customer journey” shall refer to the complete sum of experiences that customers go through when interacting with an organization. Examples of customer journeys for an energy company might include such things as:

Learn about ABC

Start, Stop, Move

Register & Manage Online Account

Payments & Service Continuity

Service Disruption & Support

Track, Understand, and Manage Usage

Proactive Communications

A “channel” shall refer to the medium of interaction between a customer and an organization. There are various types of interaction channels. Bidirectional channels support instant two-way interactions between customers and the organization. Bidirectional channels may include traditional one-on-one or physical channels, such as talking to a representative in person or by telephone. Bidirectional channels also include digital channels such as websites, mobile and tablet apps, text messaging, social media, live chat, and email. Digital channels are accessed through computing devices such as smartphones, computers, tablets, smartwatches, or smart thermostats. Unidirectional channels are not interactive and generally support one-way communication from customers to organizations or vice versa. Examples include postal mail, print and TV advertisements, and packaging. (Techniques like QR codes can serve as “semi-live hyperlinks” that put a smidgen of reverse directionality into otherwise unidirectional channels). Every organization will have its own set of relevant channels that make up its unique omnichannel ecosystem. Channels also may be categorized as “self-service” and “non self-service.” Examples of self-service channels include: desktop or mobile websites, mobile applications, Interactive Voice Response (IVR), Short Message Service (SMS), and social media platforms. Examples of non-self-service channels include: web chat, e-mail, agent handled, paper/fax, and field/QPCs/Kiosks.

“Touch point” shall refer to a specific interaction between a customer and an organization and includes the device used, the channel used for the interaction, and the task being completed. For example, within the customer journey of visiting a movie theater, there may be five touchpoints involving five channels. At TP 1 the customer browses movie times on a laptop. At TP 2 the customer purchases tickets on a mobile phone. At TP 3 the customer calls the theater to ask a question. At TP 4 the customer downloads the tickets to a mobile phone. And finally, at TP 5 the theater scans the customers digital ticket for entry.

“Customer experience facet” shall refer to the point where a customer's journey intersects a channel. Facets contain important contextual data such as journey information, channel information, customer information, and operational information. This contextual data can then be used toward insight orchestration.

“Insight orchestration” shall refer to use of data to gather insight into customer behavior and interactions with customers.

“Engagement orchestration” shall refer to the application of real-time, facet driven contextual business logic and sampling engine to invite customers to appropriate and relevant engagement instruments or dynamically alter surveys to get at even more relevant information (e.g., based on customer segment or geography).

“API” shall refer to Application Programming Interface.

“Engagement instrument” shall refer to a vehicle for collecting data from a customer (e.g., survey) or some action performed by the customer at the invitation of an organization that is designed to elicit feedback and improve the customer experience. Suitable engagement instruments might include seeking and/or performing one or more of the following non-exclusive list of actions: voice of the customer (VOC) feedback, such as, for example via focus group participation, individual interviews, or contextual inquiries; journey deep dives; A/B Experience testing; hot topic omnibus; customer experience feedback; customer empaneling to receive customer input on relevant business services; ratings surveys; Intercultural Development Inventory (IDI) surveys; or incentive offers. consists of a survey but that is not explicitly required.

“Conversation” shall refer to a vehicle for collecting data from a customer which cycles through an organization to become actionable. A conversation might consist of a survey, a personal phone call, etc.

“In-the-moment” shall refer to something that takes place as a customer is interacting with the organization in some way. For example, if a customer is shopping at a grocery store and is prompted (either by a live person or a phone app or some other means) to share his experience.

“In-context” refers to the relevance of a conversation or an engagement instrument to a customer. In-context means that the engagement instrument or conversation is tailored to what activity the customer was actually performing. So, for example, if the customer was paying a bill, the conversation might focus on that activity.

“Treatment” shall refer to a mechanism for interacting with a consumer. Examples include a visual indicator on a computer screen such as a 5-star rating at the bottom of a page, or a drawer icon docked to the side of the screen. Treatments may also comprise electronic mail communications. Treatments may be bundled (1 or more treatments) for logical reasons into groups i.e., “treatment groups.” This can be done to enable A/B testing of treatments to measure effectiveness.

“Orchestration path” shall refer to a filter that defines some subset of the traffic coming to the orchestration engine to enable easy filtering of API calls. The path may associate a specific filtered subset to a treatment group for delivery of some treatment to a customer. Orchestration paths define identifying parameters for API calls, for example, any API calls that have a parameter X equal to Y.

“Site” shall refer to a digital property, often a website, that can be instrumented with sampling agents so that orchestration can take place. Other exemplary sites include mobile applications or IoT systems, such as a store passive monitoring system that feeds data to orchestration

“Sampling agent” shall refer to a piece of software or mechanism for linking a customer to the system. It allows interception of customer activities that enables the delivery of in-the-moment, contextually relevant treatments to that customer. Calls to the orchestration API generally originate from some agent. This is also known as the “OUA” or “orchestration-user-agent” or “sampling agent”.

| Agent | Description |
|---|---|
| Treatment Component | Enables in-line delivery of a |
| | rating scale question onto an |
| | existing web page |
| Website Surveys | Enables passive and direct |
| Component | invitations to take a survey that |
| | overlay existing website content |
| Embedded Survey | Enables directly embedding an |
| Component | SI (supplemental instruction) |
| | survey within a webpage. May |
| | be accomplished with an iframe. |
| Lazy Treatment Component | A companion to the treatment |
| | component. This component |
| | enables treatment decisions to |
| | be made before the treatment is |
| | actually displayed to the |
| | customer. |
| Short link | Enables orchestration routing of |
| | customer surveys via a survey |
| | launch link |
| API Call | API called directly by client |
| | systems |

“Instrumentation” shall refer to the process of integrating within existing systems to gather information and enable activities within the existing processes. In the case of orchestration this may mean enhancing an organization's systems to make calls to the orchestration APIs at various points along the system such as anytime a customer visits a web page, or makes a call to their IVR system, etc.

“Empanelment” shall refer to empaneling organization customers and thereby enabling richer and more extensive engagement opportunities on those individuals without subject organization IT involvement.

“Impression” shall refer to a data point counted when a treatment is presented to or activated by (e.g., in the case of a short link in Facebook) a respondent.

“Click” shall refer to a data point counted when a respondent responds to a treatment, for example, when a drawer is presented and is clicked by the respondent. As another example, in the case of embedded surveys on a webpage, a click can be counted if the respondent submits the first page of the survey that is presented to them.

“Customer experience facet” shall refer to the point where a customer's journey intersects a channel.

“Catalog” shall refer to a persisted set of entities (e.g., users, customers) maintained as a source of information intended to inform engagement orchestration, analysis, and subsequent engagement instrument invitation processing.

“Path Discrimination” shall refer to the method upon which an engagement treatment will be determined for a given user within a specified context.

“Action Hinting” shall refer to the heuristic process of determining the action-ability of a given case.

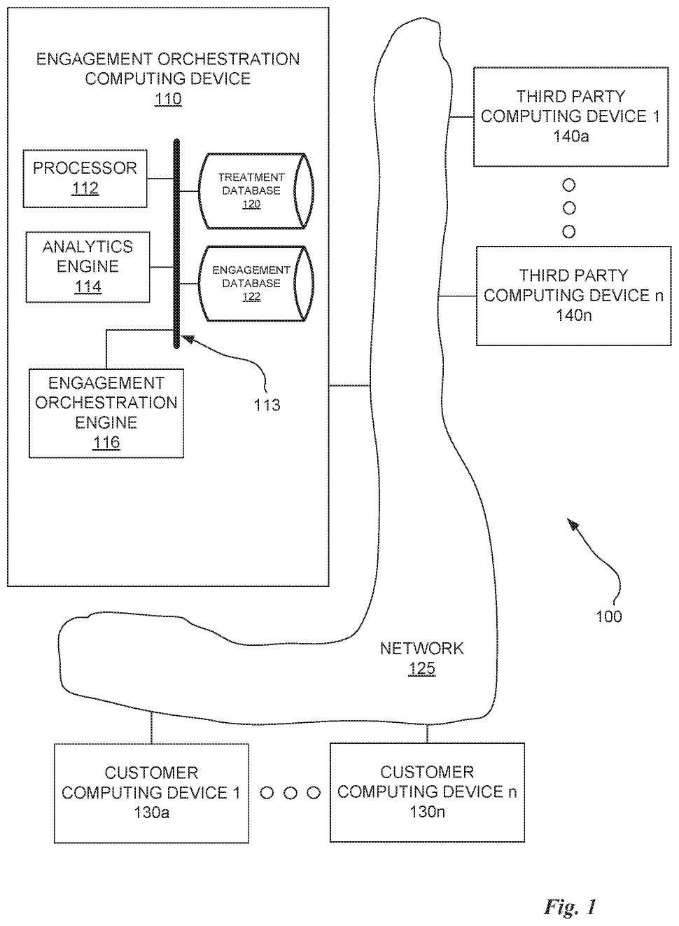

These definitions as used throughout will provide a basis for the detailed description of the embodiments that is presented below in conjunction with FIGS. 1-10 after a brief overview of the overall systems and methods.

By way of an overview, systems and methods for engagement orchestration and enhanced customer experience management that is suited to utilize probabilistic determinations based on collected customer data throughout a complex customer experience ecosystem. Such systems and methods may inform frontline and strategic business investment and improve overall customer experience. According to an aspect, the engagement orchestration systems and methods may dynamically collect customer data through multiple channels across a complex client experience ecosystem.

According to another aspect, the engagement orchestration systems and methods may be capable of integrating into a subject organization's client experience ecosystem in order to collect, analyze, process, and report data and deliver engagement instruments to customers. Such systems and methods may be realized through an engagement orchestration engine to facilitate the overall optimization of the engagement orchestration while data analysis, processing, and reporting may be performed by an analysis engine.

These functional computing blocks (e.g., engines) may be part of an engagement orchestration provider (EOP) computing platform. As such, the EOP computing platform may also be configured to integrate with third party platforms via a computing network (e.g., an intranet or the Internet) used by a subject organization to effectively collect data and deploy engagement instruments.

According to another aspect, the engagement orchestration systems and methods may be capable of selecting and deploying one or more engagement instruments in near real time from a collection of available engagement instruments. These engagement instruments may be selected from a collection of available engagement instruments based on contextual information such as, for example, journey information, channel information, customer information, and operational information. Further, engagement instruments may be selected from a group consisting of voice of the customer (VOC) feedback, such as, for example via focus group participation, individual interviews, contextual inquiries, journey deep dives, A/B Experience testing, hot topic omnibus, customer experience feedback, customer empaneling to receive customer input on relevant business services, ratings surveys, Intercultural Development Inventory (IDI) surveys, and/or incentive offers.

In implementing the systems and methods discussed herein, these engagement instruments may be selected for deployment according to predetermined and programmable engagement selection rules or criteria and may be designed and customized by an administrator of the engagement orchestration platform. The engagement instrument engagement selection criteria may be configured by an administrator of the engagement orchestration platform and such criteria (as well as the engagement instruments themselves) may be dynamically altered through use of collected data, such as surveys, based on contextual information to acquire more relevant business driven information. Similarly, participation treatments may be presented to customers through sampling agents.

Turning attention to the figures. FIG. 1 is a block diagram of a computing environment 100 for realizing the systems and methods of a dynamic engagement orchestration platform that may be used to improve customer experience according to an embodiment of the subject matter disclosed herein. Herein described is a dynamic engagement orchestration platform 100 wherein an EOP may provide a solution that allows the subject organization's customers to engage in (near) real-time (e.g., dynamic) with the EOP platform of the subject organization. Further, the subject organization's employees may be enabled to adjust and optimize the experience with customers based on engagement results. The solution will collect data in near real-time across different journeys and channels (“omnichannel”) and allow key stakeholders to follow-up to achieve desirable results based on customer engagement.

The engagement orchestration computing platform 100 may be capable of integrating into a subject organization's client experience ecosystem in order to collect, analyze, process, and report data and deliver engagement instruments to customers. From the organization side, the computing platform 100 includes an engagement orchestration computing device 110 that may be a server-based computing environment realized across one or more distinct computing units. Such a computing device 110 may include a master controller of processor 112 that communicates with other computing modules via a master communication bus 113. Other modules at the engagement orchestration computing device 110 include an analytics engine 114, an engagement orchestration engine, a treatments database 120 and an engagements database 122, all of which may be communicatively coupled to master communications bus 113. Further, the entirety of the engagement orchestration computing device may be communicatively coupled to a computer network 125 (e.g., an intranet, the internet, or both).

Collectively, these computing units/components may facilitate the collection of data from customers through customer computing devices 130a-130n (e.g., via engagements stored in the engagements database 122 received from customers) that engage with the subject organization as well and dynamically tailor the presentation of data to customers (e.g., via treatments stored in the treatments database 120 presented to customers). Within the engagement orchestration computing device 110, the engagement orchestration engine 114 to facilitate the overall optimization of the engagement orchestration with customers while data analysis, processing, and reporting may be performed by an analysis engine 116. Further, the engagement orchestration computing platform 100 may also be configured to integrate with third party platforms 140a-140n via a computing network 125 such that the subject organization may effectively collect data and deploy engagement instruments using such third=party services as well.

The platform 100 may enable omnichannel data collection through engagement instruments within the broader customer experience ecosystem. Contextual data fields can be provided in near real-time (for example, via a web-browser application executing on the customer's computing device) to support solution requirements. In one embodiment, a third-party platform supporting JavaScript components and associated dependencies will allow for EOP's website surveys, for example, to be enabled within the third party's cloud services in support of client customer digital interface requirements. The JavaScript components may use an orchestration API to enable such aspects as immediate presentation of surveys based on customer context as well as other orchestration-determined actions. EOP's orchestration API can be called using any third party's capabilities such as workflow, outbound messages, and process builder Apex callouts. EOP's orchestration API calls may include sufficient context to enable orchestration and reporting requirements. The orchestration API may send e-mail invitations or perform other actions based on context.

EOP's services cloud may be integrated into a third party's platform 140a as a connected application. This will allow connectivity such as enabling access to information for orchestration and allow for data to be mapped back into third party data objects. Contextual data fields can be provided to EOP in real-time to support VOC solution requirements. These contextual data fields inform engagement orchestration decisions for engagement instruments in addition to requirements for, amongst other things, IVR data integration, closed loop processes and reporting, survey level reporting, business reporting, CE team analytics reporting, text analytics, mapping, and offline processes for data enrichment.

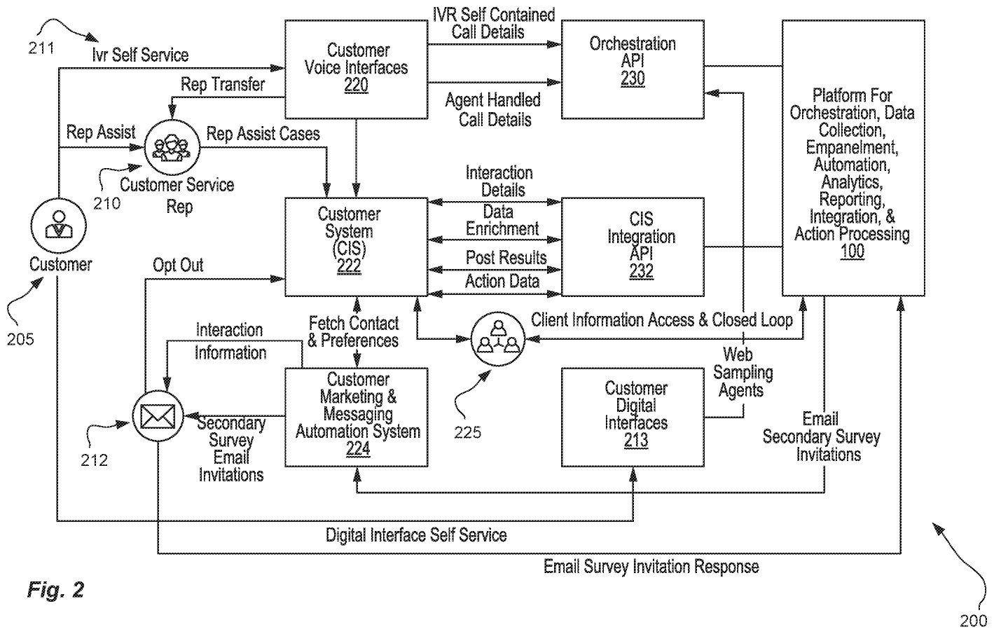

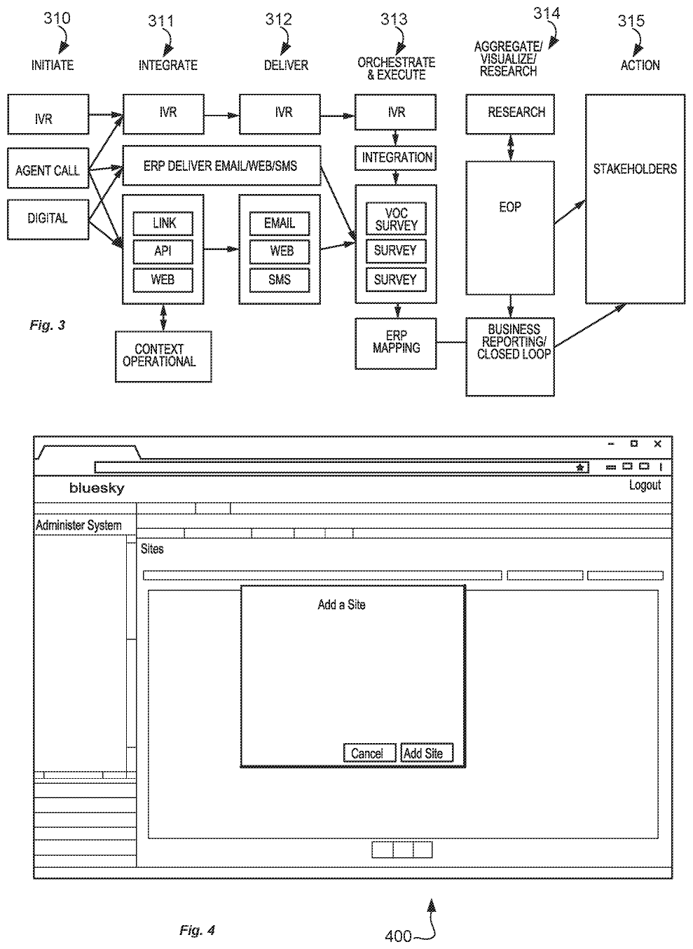

FIG. 2 is a diagram 200 of data flow (as illustrated by data flows paths) in the integrated engagement orchestration system 100 of FIG. 1 illustrating the architecture and flow of data through a subject organization's customer experience ecosystem according to an embodiment of the subject matter disclosed herein. The diagram 200 shows the points of interconnectivity (e.g., data flow paths) between EOP, third-party service functionalities, and the subject organization. These various interconnections represent opportunities to either collect data from a customer through an engagement or to deliver data to a customer through a treatment (or both). As discussed below, FIG. 3 depicts the data flow for customer interactions and data collection via discrete communication channels (e.g., IVR, agent call, web chat, e-mail, SMS) at initiation and integration phases.

Keeping focus of FIG. 2 for now, the dynamic engagement orchestration system 100 may support a variety of sharing and embedding methods for executing engagement instruments as part of an omnichannel customer experience feedback program. In FIG. 2, a customer 205 may interact with a subject organization in a number of different ways. As shown, these ways include interacting directly with a customer service representative 210, interacting with an IVR 211, and corresponding through electronic communication such as via email 212 or via an interactive browsing session 213. Generally speaking, voice-based interaction may be coordinated through a customer voice interfaces 220, service representative interaction is coordinated through a Customer Information Service (CIS) 222, and electronic communication is coordinated through a customer marketing and messaging automation system 224. Data collected and distributed via voice or electronic communication systems may be utilize an orchestration API 230 for assimilating and drawing data form the orchestration platform 110. Similarly, data collected and distributed via customer information service systems 222 may be utilize an CIA API 232 for assimilating and drawing data form the orchestration platform 110.

Each of these ways of communicating involve some method of engagement with the customer 205. These methods of engagement may include, for example: deploying URL (Web) links (with parameters for passing merged fields) supporting distribution of e-mail, social media, SMS, website triggers, and the like; embedding feedback survey questions in an HTML, e-mail, or web page; and integrating feedback surveys within a website using a JavaScript snippet or third-party service JavaScript components. The engagement orchestration system 100 may be called using a URL-based web-link with appropriate merge fields for survey content determination within the survey system at launch time without precoding explicit survey ID target links within the calling system based on current context. However, using URL based web links for all channels (e.g., desktop/mobile web) can limit flexibility in orchestrating customers within a customer experience ecosystem; thus, in one embodiment, a JavaScript component may be used for desktop/mobile web or other applicable channels.

Each data flow path may support merge fields for feedback survey implementation and the following types of fields may typically be passed when launching surveys: Contact ID, First Name (if personalization is required), Last Name (if personalization is required), journey context information (e.g., journey, channel, interaction, task), referrer information (e.g., account page context, IVR, and the like), operational information (e.g., operating company), and Representative/Agent name and identifier (if applicable). Surveys launched using URL-based web-links can accept merge fields as part of the launch link. Merge fields allow for variables to be passed to the survey. These variables can be used for personalization, contextual business rules, survey selection, mapping data back to a third-party service or for updating third-party service records with meaningful associated values. For example, it may be desirable to send an Account ID or Contact ID to a survey

EOP JavaScript components can be used to implement passive/active feedback survey opportunities for customers interacting with third-party service cloud solutions. These components can be integrated to cover different use cases such as passive feedback using a drawer mechanism, embedded questions on specific pages such as a payment confirmation page, and responsive survey lightboxes. When integrating EOP's JavaScript components, standard website information such as page title, document URL, user/contact ID (if authenticated) is available. In addition, a comma delimited list of values can be specified (e.g., explicit values, formula fields). Variables passed will be available as survey launch parameters.

The dynamic engagement orchestration system 100 may support the implementation, customer experience, administration, and integration requirements for the subject organization. Implementation features of subject organization's customer experience management system may comprise: built on top of an EOP data collection engine; EOP to third-party service platform connection; modern user interface for feedback survey creation; theme support for configurable look and feel; distribution support for embedding within digital sites, feedback survey URL links, and messaging (e.g., email, SMS).

Administration features of the subject organization's customer experience management system may comprise: orchestration of feedback survey experiences and other engagement instruments across journeys, interactions, channels, and survey modes; near-real-time feedback survey results and status reporting; and business rules such as DNC and respondent participation controls.

Customer Feedback Survey Experience features of the subject organization's customer experience system may comprise: in channel real-time or scheduled customer feedback experience across multiple modes of data collection independent of interaction channel; mobile-friendly responsive design for online feedback surveys; push and/or pull invitations across different modes; and active, passive, and inline feedback survey.

Platform Integration features of the subject organization's feedback survey system may comprise: mapping data back into third-party service allowing third-party service workflows for alerting, reporting, closed loop processing, and customer records extracting data for sampling and other engagement initiative requirements; operational enrichment data extraction for engagement data supplementation; messaging integration for push campaigns; and text analytics for sentiment analysis and classification.

Feedback survey programming may comprise business rule implementation for feedback survey sampling, feedback survey programming and changes, feedback survey to third-party service mapping implementation for limited feedback survey data (e.g., last survey response overall satisfaction), and any additional third-party service programming or configuration services. IVR data may be integrated into EOP's data repository. EOP's engagement orchestration system API can be called to support data integration requirements. Batch data integration may also be supported. Contextual data for customers providing feedback via IVR may be posted to EOP's system. Customers who do not complete an IVR survey may be pushed an e-mail invitation based on engagement orchestration business rules.

In some embodiments, the process of deploying and configuring dynamic engagement orchestration may follow the pattern of: EOP identification of websites and other digital properties within the subject organization for instrumentation. Suitable properties include a corporate website, my account website, a mobile application or the like. EOP may deploy one or more sampling agents throughout the subject organization's properties. In one embodiment, a website surveys component may be the only one deployed, however, there may be a variety of agents deployed among the various properties. A site record can be identified for the digital properties and sampling agents are deployed to the sites using site IDs and other configuration identifiers. Sampling agents are key to enabling orchestration. An agent, for example, intercepts customer activities allowing collection, analysis, contextual based decision making, and the delivery of in-the-moment, contextually relevant treatments or engagement instruments to that customer. Using the EOP services cloud or other platform, EOP designs one or more orchestration campaigns.

FIG. 3 is another diagram depicting customer interaction, sampling agent engagement, and data collection via channels (e.g., IVR, agent call, web chat, e-mail, SMS), system components, and integration with the subject organization and third-party technology within the integrated engagement orchestration system of FIG. 1 according to an embodiment of the subject matter disclosed herein. In FIG. 3, each column may represent a category describing a timeframe with regard to various interactions. For example, when an interaction is first initiated, communication may take place via one or more channels of IVR, agent call, or digital means (e.g., email, and the like), hence the term omnichannel. Thus from FIG. 3, one can see the different categories spanning these omnichannel engagements with customers. These categories include initiation 310, integration 311, delivery 312, orchestration and execution 313, aggregation/visualization/research 314, and action 315. The various components described with respect to FIG. 2 may be utilized during interactions that fall into one or more categories as presented here. A skilled artisan understands these various omnichannel communications, so each one will not be described herein for brevity. However, a global discussion about a web-based service is described next with respect to FIG. 4.

FIG. 4 is a screenshot 400 illustrating an example implementation of the engagement orchestration system of FIG. 1 illustrating how sites may be set up, added, enabled or disabled according to an embodiment of the subject matter disclosed herein. Generally speaking, the EOP may interact or otherwise engage with customers and providers through web-service based sites that may be engaged through a common web-browser program. In various embodiments, setting up sites may be a one-time step that is performed at the beginning of the orchestration configuration and may or may not be modified thereafter. A subject organization may have a single site that might be for their corporate website or customer-facing site (e.g., myaccounts.customer.com). Alternatively, a subject organization could have multiple sites, one for each of their websites as well as additional sites for non-website system. For example, there may need to be a site defined for a mobile application.

The site is a collection of configuration parameters that describe how the orchestration engine will behave when called. The site includes the rules to be processed (as determined by treatments and orchestration paths) and higher-level configuration that the rules are processed through (defines the panel(s) to interact with, and other options). Sites may be configured within a customer experience ecosystem or platform and each site has a unique Site ID assigned to it, which informs how the API is called when integrated into an organization's systems. Sites may be configured with custom properties to control function. Sites may also be configured with a set of state objects that work together to collect all of the relevant information for each API call. State objects represent the parameters sent to the API as well as other contextual information that needs to be associated with it. Sites may be set up, added, enabled or disabled within an EOP engagement orchestration system.

Each site may have custom properties to configure various aspects of its behavior. FIG. 4 is but one example of a screen shot 400 of one site. The screen shot shows a number of data collection and delivery components for facilitating aspects of the engagement orchestration system 100 of FIG. 1. For example, see the table below.

| Property Name | Description | Example Value |
|---|---|---|
| DEFAULT_PAYLOAD_FORMAT | Default value for | URL Encoded |
| | the PayloadFormat | |
| | input parameter, | |
| | used for shortlink | |
| | processing where | |
| | including that | |
| | argument would | |
| | require extra | |
| | characters. | |
| DEFAULT_OUTPUT_FORMAT | Default value for | HTML |
| | the OutputFormat | |
| | input parameter; | |
| | used for shortlink | |
| | processing, where | |
| | including that | |
| | argument would | |
| | require extra | |
| | characters | |
| DEFAULT_URL_RESULT | Default URL output | https://survey.EOPonline.com |
| | when a survey link | |
| | is requested. This | |
| | should be | |
| | something generic | |
| | that displays a | |
| | reasonable | |
| | message if a | |
| | targeted link | |
| | cannot be | |
| | generated; this | |
| | property exists to | |
| | avoid broken links | |
| | or ugly error pages. | |

Each site can be configured with state objects working cooperatively to collect relevant information for each API call. State objects represent the parameters sent to the API as well as other contextual information associated with it (e.g., geolocation, IP address and the like). State objects may be configured using the EOP engagement orchestration system. Each state object has a name, an object class and configuration as shown in the table below.

| Attribute | Description |
|---|---|
| Object Name | This is an internal name used by the orchestration engine. |
| | It must be unique within the site. Object names must be |
| | valid object names A-Z, a-z, 0-9. They should always |
| | begin with a letter. Object names may be used in |
| | orchestration paths in the format |
| | “ObjectName.SomeField” though that is usually |
| | not necessary. |
| Object Class | Each state machine is implemented within the |
| | orchestration engine as a class derived from |
| | SIStateMachine. Each state machine will have a class |
| | that begins with “SIStateMachine”. The list of |
| | available state machines is shown below. |
| Configuration | Each state machine may require custom configuration. |
| | See the object class definitions below for more |
| | information. |

Website engagement participation treatment sampling agent may be embedded within an existing website using a JavaScript code snippet that may be inserted into every page on the site. The basic snippet can be accessed from a JavaScript Snippet tab in the EOP engagement orchestration system. Site rules are how engagement orchestration works behind the scenes. A site rules tab is a tool to allow the EOP to review the configuration of the site decision rules separate from the orchestration hierarchy. In some instances, the site rules tab is not used to configure the site rules but merely to review them.

Site activity (e.g., API calls) may be reviewed at the EOP engagement orchestration system. An activity tab may provide a grid view of all recent API calls to the orchestration engine for the selected site. The list may be filterable by user agent or whether or not the error occurred as well as by the date of the API call. The engagement orchestration system 100 may allow the user to review a Detailed Site Activity Record which may provide guidance when specifying orchestration paths. The HTTP Body within that record may contain the parameters provided to the API when it was called. These along with the URL parameters and any other variables brought in by the state engine may be used when defining orchestration paths.

Site context data in the form of a context record may be created each time the orchestration API makes a decision to deliver a treatment or take some other action based on an API call. The context record captures all of the information provided to the API as well as any values brought in by the state machines. Context records can be viewed through the EOP engagement orchestration system and used after they are created to enrich survey data or in the execution of other operational procedures. Context data may have retention limits or be kept permanently.

Campaigns are a high-level organizational unit for orchestration and is a collection of treatment groups, treatments and orchestration paths. A campaign might be short term such as “October Launch Preview Campaign” or more long term such as “Ongoing VOX Interactions”. “VOX” means “voice of the consumer.” Campaigns may be created, configured and disabled through the EOP engagement orchestration system 100.

Treatments are visual or non-visual experiences provided to a customer or because of a customer. Visual treatments are user-interface experiences that are immediately delivered to customers “in-the-moment” via orchestration agents that are running within the website they are interacting with. Examples of visual treatments are provided in the table below.

| Treatment | Description | Agent |
|---|---|---|
| Display a Rating | Displays a rating scale on the web | Treatment |
| Scale | page the user is on. (e.g., A 5 star | Component |
| | rating) | |
| Display a Drawer | Displays a passive drawer on the | Website Surveys |
| | web page the user is on. (e.g., | Component |
| | docked to the left hand side of the | |
| | screen) | |
| Display a Drawer | Displays a passive drawer icon on | Website Surveys |
| | the web page the user is on (e.g., | Component |
| | bottom right corner or bottom left | |
| | corner) | |
| Display a Popup | Displays a popup survey invitation | Website Surveys |
| | asking user if they want to take a | Component |
| | survey | |
| Display a Popup | Displays a popup lightbox and | Website Surveys |
| Lightbox | launches the survey | Component |
| Embed a Survey | Displays a survey within an iframe | Embedded Survey |
| | on the web page the user is | Component |
| | accessing. | |
| Direct a User to a | Specific to shortlinks, this directs a | Shortlink |
| Survey | user to a specific survey. (e.g., | |
| | User clicks a link in an email) | |

Non-visual treatments may be experiences such as sending an e-mail invitation or calling an API. Non-visual treatments are useful for enabling the complete engagement experience and may be performed by the EOP as opposed to agents running within the subject organization's website. For example, the treatment “send an e-mail” relates to sending a specific e-mail to someone. The treatment “schedule a time dependent task” involves scheduling a time dependent task (e.g., send secondary invitation after 24 hours of no response). The treatment “make an API Call” involves calling a specific API to perform some other action. Treatments may be designed via EOP engagement orchestration system 100.

Orchestration paths tie treatments to customer experiences. For example, as a customer browses the subject organization's website or uses the applications, deployed sampling agents make calls to the system to determine if a treatment should be displayed. For example, a customer logs into their account and pays their bill. On the last page of the bill payment, the deployed sampling agent may make a call to the orchestration API delivering details (data) based on parameters that were pre-determined and coordinated with the subject organization. The parameters usually include things like the page URL and page title, user IP address, and user device. Parameters may also include client-specific information such as customer ID and the like. The orchestration engine may also append additional parameters such as the user panel member ID or IP geolocation information. All of that information is processed against the paths defined in the EOP engagement orchestration system to determine what treatment group, if any, should be delivered to the user. Once the orchestration engine finds a path that matches the parameters sent to it by the agent, it returns the treatments associated so that the sampling agent can deliver the treatment to the user. In the case of the bill payment example, this might be to present the end user with a 5-star rating titled “Please rate your payment experience”.

Each orchestration path that is defined may contain a single Boolean criteria statement that determines if a sampling agent should deliver a treatment. These criteria statements are powered by the EOP engagement orchestration system 100 Boolean evaluator. The orchestration engine may not enforce a standard set of fields for each API call. This information should be coordinated with the client and planned out. However, there may be common fields that are always present for calls that originate from the treatment component, website survey component and survey embedded component. For example,
page—the full URL of the page the user is on; and
title—the HTML page title of the page the user is on platform—can be “mobile” or “desktop.”
JavaScript components may also provide the following additional fields in some embodiments.
   VendorABCUSerID
VendorABCContactID
FirstName
LastName
EmailAddress.
   Some state machines, or state objects, also provide a list of standard fields if configured. The GeoLocation state machine provides the following additional fields in some embodiments. The following Boolean operators are available for use in the Boolean criteria statements as well.
=Example: SomeParameter=123
Example: SomeParameter>123
<Example: SomeParameter<123
>=Example: SomeParameter>=123
<=Example: SomeParameter<=123
!=Example: SomeParameter !=123
< >Example: SomeParameter< >123
IN Example: SomeParameter IN (1,2,3)
NOT IN Example: SomeParameter NOT IN (1,2,3) LIKE Example: page like ‘% My-Account %’
NOT LIKE Example: page not like ‘% My-Account %’ CONTAINS Example: page contains ‘My-Account’
OR statements are supported. Example: page contains ‘My-Account’ OR page contains ‘My-Billing-Information’
AND statements are supported. Example: page contains ‘My-Account’
AND SomeParameter=123
ORNOT statements are supported. Example: page contains ‘My-Account’
OR NOT
SomeParameter=123
ANDNOT statements are supported. Example: page contains ‘My-Account’ AND NOT
SomeParameter=123

In addition to simple conditional expressions on fields and values, functions can be used within the statements. For example, HOUR (now( )=12 would only be true between noon and 1 pm on each day.

### Example Subject Organization Website Engagement Orchestration System Integration

The following example illustrates how a subject organization customer digital interface property may be integrated with the EOP engagement orchestration system. In this embodiment, specifications, requirements, survey results, confirmation e-mail with survey URL and survey output, survey enrichment via fetching of Third-party service case and transaction details, and secondary survey invite are described.

General website roles and responsibilities within the EOP engagement orchestration system are as follows: (1) the website system is responsible for providing connection information and contextual details including site ID, customer ID, interaction ID, and other relevant contextual information to aid in engagement orchestration; (2) the website system is responsible for providing engagement treatment integration and EOP is responsible for executing engagement orchestration, engagement instrument execution, as well as provide all engagement result information and analysis; (3) engagement instrument analysis enrichment data is fetched from Third-party service leveraging EOP connected API adhering to proper security profile; (4) EOP managed/connected API provides data exchange needed between Third-party service and EOP platform; (5) Third-party service customer information and service management system maintains customer cases, sub transaction type, preferences and contact data in support of EOP engagement orchestration system; (5) marketing and messaging automation system provides outbound transaction confirmation e-mail based on available preference and contact data where Third-party service is system of record; and (6) EOP engagement orchestration system publishes dynamic data reports and supports secondary engagement instrument e-mail invitation.

A table describing an exemplary contextual data object that can be provided to EOP in real-time to support dynamic engagement orchestration requirements. These contextual data fields inform orchestration decisions for engagement instrument determination in addition to requirements for data integration, closed loop processes and reporting, survey level reporting, business reporting, CE team analytics reporting, text analytics, SFDC mapping, and offline processes for data enrichment.

Further a table describing an exemplary data object that can be persisted to the subject organization's system. The data fields listed in the table could be defined as part of a custom data definition created by the subject organization named, for example, Data Results (or as appropriate according to naming conventions). Appropriate record types and layouts should also be defined to reflect key differences in available data based on program implementation requirements (e.g., agent handled IVR call surveys contain question data not relevant to web surveys).

Further yet, a table describing an exemplary secondary invite data object definition. The process for creating this object is generally shown in the “Email Secondary Survey Invitations” and “Secondary Survey Email Invitations” steps in FIG. 1. In this embodiment, EOP publishes the secondary data survey requests to support secondary survey engagement push email invitation requirements. EOP must receive data for all relevant interaction launch points regardless of initial primary (pull or push) engagement instrument completion. EOP will use this information superset (A) in combination with the subset (B) of completed survey information to identify the subset (C) of customers who were given an opportunity to engage but did not complete engagement instrument. Partial engagement instrument completes will not be considered for a secondary engagement invitation. Subset C of customers will be transferred to subject organization's marketing & messaging automation system from EOP within a 24-hour period of time for subsequent sending of secondary push email engagement invitations. Secondary engagement email HTML URL links will be provided by EOP to support secondary push engagement invitation email delivery from subject organization's marketing and messaging automation system. In addition to the provided HTML URL link, EOP will also provide a set of email content fields. This data will reside in a secondary push data object within subject organization's system which will be populated by EOP.

A data enrichment process is generally shown in FIG. 2 between the subject organization CIS and the EOP CIS integration API. In this embodiment, bulk API is used to fetch detailed data with proper security in place (e.g., no customer name or e-mail address). Third-party service management system security profile is configured for EOP API to access a subset of the data objects and attributes. EOP calls the Third-party service management system bulk API and fetches data elements to support engagement instrument orchestration and downstream business requirements: contact ID, case ID, case type, transaction type, WO type, agent ID, and/or other data elements within case, account, contact, preference objections.

### Comprehensive Dynamic Engagement Instrument Orchestration

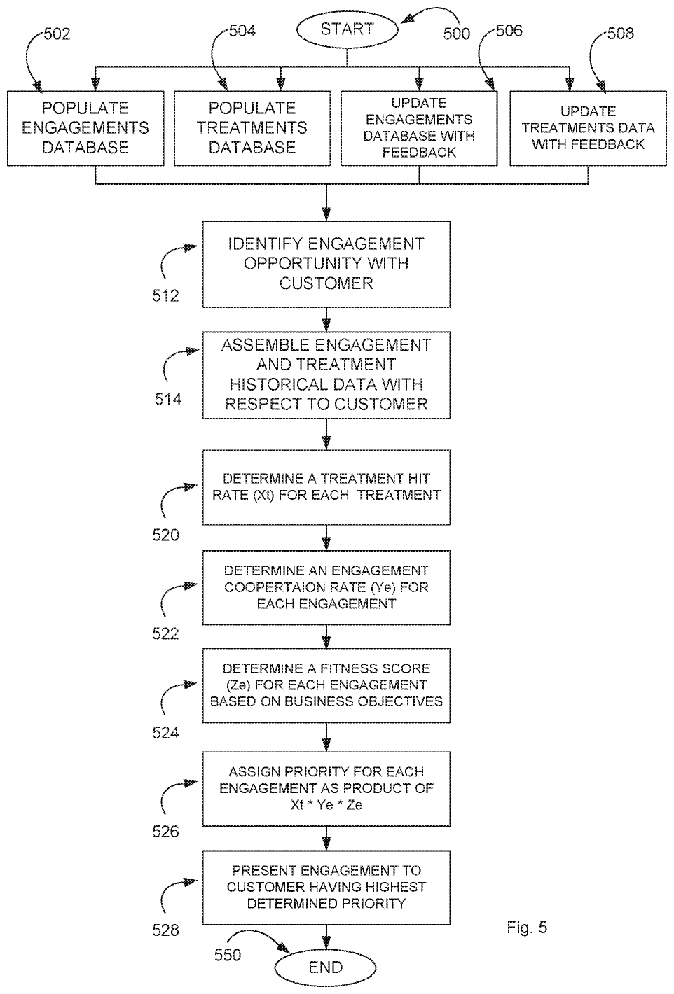

FIG. 5 is a flow chart illustrating exemplary computer-based method for dynamic selection of engagement instruments to be presented to users according to an embodiment of the subject matter disclosed herein. As generally shown in FIG. 5, one embodiment of a computer-based method may start at step 500. The overall method may include persisting data to one or more databases including initially populating an engagements database with a plurality of engagements at step 502 as well as populating a treatments database with a plurality of treatments at step 504. Further, as data is collected via various engagements that have been deployed, engagement instrument results are persisted as results to the engagement database at step 506 as necessary to support data processing, analysis, and reporting objectives. Further, as data is collected via various treatments that have been deployed, treatment results are persisted as results to the treatments database at step 506. Various output reporting techniques and visualizations are utilized to meet stakeholder requirements for information consumption, analysis, operationalization, and business process improvement.

As mentioned above, the EOP engagement orchestration system 100, in some embodiments, can intelligently provide optimal customer experience at a specific customer point of engagement based on the relevant business context through the near real-time rules based and contextual selection and presentation of relevant engagement instruments to a customer from a collection of available pre-programmed engagement instruments stored in a database. Available engagement instruments might include, for example, focus group participation, individual interviews, or contextual inquiries; journey deep dives; A/B Experience testing; customer experience feedback; customer empaneling to receive customer input on relevant business services; ratings surveys; IDI surveys; or various incentive offers. In doing so, the system 100 taps into the customer service ecosystem to intelligently sense, understand, examine, and experiment across multiple facets within the customer experience ecosystem. Thus, the method may identify an engagement opportunity with respect to a customer at step 512.

Next, at step 514, specific data may be retrieved from the engagement and treatment databases including historical data about aspects of each engagement and treatment with respect to the specific customer being consider for a customized and orchestrated engagement. Such historical data may include various rates of success with respect to customer interaction and engagement. Such historical data may also be filtered with respect to minimum thresholds, maximum thresholds, or error thresholds corresponding to business objectives of either the customer or the subject organization. As this historical data is assembled, persisted, updated and/or retrieved, priority ratings may be calculated for each engagement that is persisted in the engagement database as discussed next with respect to steps 520-528.

In an embodiment, each engagement may be assigned a priority rating with respect to the identified customer that is a function of a) a context associated with the identified customer, b) a treatment instrument hit rate, c) an engagement instrument cooperation rate, and d) an engagement instrument fitness score. An identified customer may be as simple as a contextual identity of a customer in which the subject organization has determined is in need of a customized engagement. Thus, the identified customer may be self-selecting in the case of choosing a channel to contact the subject organization, e.g., a cold call, a directed email, answering a survey, and the like. In other embodiments, the identified customer may be chosen by the subject organization as part of a campaign to target specific kinds of customers (e.g., contextual) for a specific business purpose. For example, a subject organization may establish quotas for specific engagements. Quotas may be directed individual segment profile characteristics contextually relevant to business objectives. Thus, the subject organization may use the EOP to orchestrate engagements based on gender where there is a desire, for business objective purposes, to have a maximum of 100 customers complete an engagement instrument comprised of 75 males and 25 females.

At step 520, the treatment instrument hit rate may be a function of the rate in which a treatment is deemed successful (e.g., proper data is presented to any customer wherein satisfaction of the customer was achieved). At step 522, the engagement instrument cooperation rate may be a function of the rate in which an engagement instrument is deemed successful (e.g., proper data is collected from any customer. At step 524, the fitness score may be a function of the business objective thresholds established by a subject organization in a contextually relevant evaluation based on the associated context and/or identity of the customer that will receive the dynamic customized engagement. For example, a fitness score may be a function of calculating contextually relevant treatment click rate across impressions for contextually similar individuals presented with the treatment and calculating contextually relevant engagement instrument cooperation rate for contextually similar individuals presented with the engagement instrument.

As each of these three variables is established, a priority rating for each possible engagement may be calculated and assigned. In one embodiment, the priority rating is calculated, at step 526 as a product of the a) treatment instrument hit rate, b) engagement instrument cooperation rate, and c) engagement instrument fitness score. In other embodiments, one or more of these variables may carry greater or lesser weight through assigned weighting variables. When all possible engagements are assigned a priority with respect to a specific identified customer, an engagement having the highest priority rating assigned may be selected as an engagement to deploy at step 528. Further, the identified customer may be “identified” by contextual elements associated with various customers with respect to a customer's journey, interaction channel, and interaction facet. That is, the actual “identity” of the customer need not be known, but rather some manner of context in which the customer is identified, e.g., cold call, highly-valued long-time customer, female, retiree, and the like. After selection of the highest priority rated engagement instrument, the method may end at step 550 or repeat for additional iterations.

The foregoing method may further be described by some or all of the following pseudo code which illustrates an example of how to select paths comprised of treatments and engagement instrument combinations according to an embodiment of the subject matter described herein. In one embodiment, the pseudocode for one method comprises 9 steps:

Step 1: Determine which paths are eligible for the current orchestration
request
Terms:

eligible_paths = a list/array/vector of the paths (combination of

treatment and engagement) where all path criteria are satisfied
Step 2: Gather relevant priorities for all qualified paths and weight settings
Terms

ppriority = Path priority
tpriority = Treatment priority
epriority = Engagement priority
fweight = Fitness weight (having value 1−N)
pweight = Priority weight (having value 1−N)
cweight = Confidence weight (having value 1−N)
nweight =Need weight (having value 1−N)

Step 3: Update Overall click counts/rate and cooperation rates for each
path
Terms:

oti = Overall treatment impressions
otcc = Overall treatment click count
oei = Overall engagement impressions
oecc = Overall engagement completion count
otcr = Overall treatment click rate: =otcc/oti
oecr = Overall engagement cooperation rate: = oecc/oei

Step 4: Update context-relevant click count/rate and cooperation rate for
each path
Terms:

cti = Context-sensitive treatment impressions
ctcc = Context-sensitive treatment click count
cei = Context-sensitive engagement impressions
cecc = Context-sensitive engagement completion count
ctcr = Context-sensitive treatment click rate: = ctcc/cti
cecr = Context-sensitive engagement cooperation rate: = cecc/cei

Step 5: Update engagement need progress valuation
Terms:

eneedp = Engagement need progress

Step 6: Assign a gamma value to each path. Gamma value range
decreases based on lowest quantity of available data (MIN(oti, cti))
Terms:

gamma = Random value in the range 0-N where N never exceeds 1

and is determined based on MIN(oti,cti) by pre-defined ranges
Step 7: Calculate probability inputs for each path:
Terms:

fit = Fitness score: =(1−1*(1−ctcr)*(1−cecr)
cpriority = Computed Priority: =LOG(LOG(LOG

(ppriority*tpriority*epriority)*(100−eneedp)))

confidence = Confidence score: =(1 − (1−otcr)*(1−oecr))

Step 8: Calculate a probability for each path
Terms:

rprobability = Raw probability: =LOG(fit+cpriority+confidence)
probability = Final probability: =ABS(raw_probability * gamma)

Step 9: Calculate a weighted rank for each path
Terms:

wprobability = Weighted probability: =ABS(probability + (fit*

```
  (fweight−1)) + (cpriority * (cweight−1)) + (confidence * (cweight−1) +
  (((100−eneedp)/100) * (needweight−1))
```

wrank = rank(wprobability)

As an example algorithm for a computer-readable medium with computer-executable instructions, the following shows one embodiment in a non-transitory computer-readable medium having computer-executable instructions for:
a. providing for assignment of priorities to path treatment and engagement combinations;
b. providing for configuration of path evaluation criteria;
c. providing for assignment of minimum, maximum, and error thresholds to individual segment profile characteristics;
d. providing for assignment of weight values for fitness, priorities, confidence, and needs;
e. storing path treatment and engagement combination configuration and individual segment profile characteristic configuration in a database;
f. evaluating satisfaction of path criteria across a plurality of path configurations;
g. calculating treatment click rate across impressions for all individuals presented with the treatment;
h. calculating contextually relevant treatment click rate across impressions for contextually similar individuals presented with the treatment;
i. calculating engagement instrument cooperation rate for the plurality of contextually relevant configured engagement instruments;
j. calculating contextually relevant engagement instrument cooperation rate for contextually similar individuals presented with the engagement instrument;
k. calculating the current state as a percentage of the completion progress of individual segment profile characteristics contextually relevant to business objectives;
l. calculating fitness score based on 13.j, and 13.h;
m. calculating computed priority based on assigned priorities and 13.k;
n. calculating confidence based 13.j and 13.k;
o. determining a selection probability of each path consisting of a treatment and engagement instrument combination based on the weighted multiplication of the assigned weights and priorities with the calculated results of 13.g, 13.h, 13.i, 13.j, 13.k, 13.l, 13.m; 13.n;
p. dynamically selecting, from the database and based on selection probabilities, a path comprising of a treatment and engagement instrument combination to be presented to an individual,
q. wherein providing for presentation of the path to the individual includes providing for assignment of priorities to paths and providing for assignment or priorities to individual treatments within each path and providing for assignment of priorities to individual engagement instruments within each path and wherein determining selection probabilities includes calculating the selection probabilities based on the priorities assigned to the paths and to the priorities assigned to the treatments and to the priorities assigned to the engagement instruments, wherein the selection probability for the path is calculated by multiplying a fitness weight and a priority weight and a confidence weight and a need weight.

FIG. 6 is a set of exemplary closed loop case management user interfaces and an exemplary workflow intended for subject organization, and other relevant stakeholders according to an embodiment of the subject matter disclosed herein. Such user interfaces may comprise a series of hypertext pages having several navigation options as is commonly understood. Thus, in one embodiment, a customer may provide feedback 610 as an initiation of communication. Then an engagement and treatment path may be selected in an action via a business rule 612 that is part of the EOP. If the engagement and treatment path is undertaken (e.g., an action), then a case record may be created 614 and a notification sent 616 to an EOP agent 618 thereby assigning the case to said agent. Based on the case now assigned to an agent, additional interaction with the customer may be initiated whereby the agent works the case 620. Further, the email communication may also go to an additional business rule processing whereby the case may also simultaneously be escalated 622. As each of these paths plays out, additional business rule processing may result in the end of the engagement and treatment path 630.

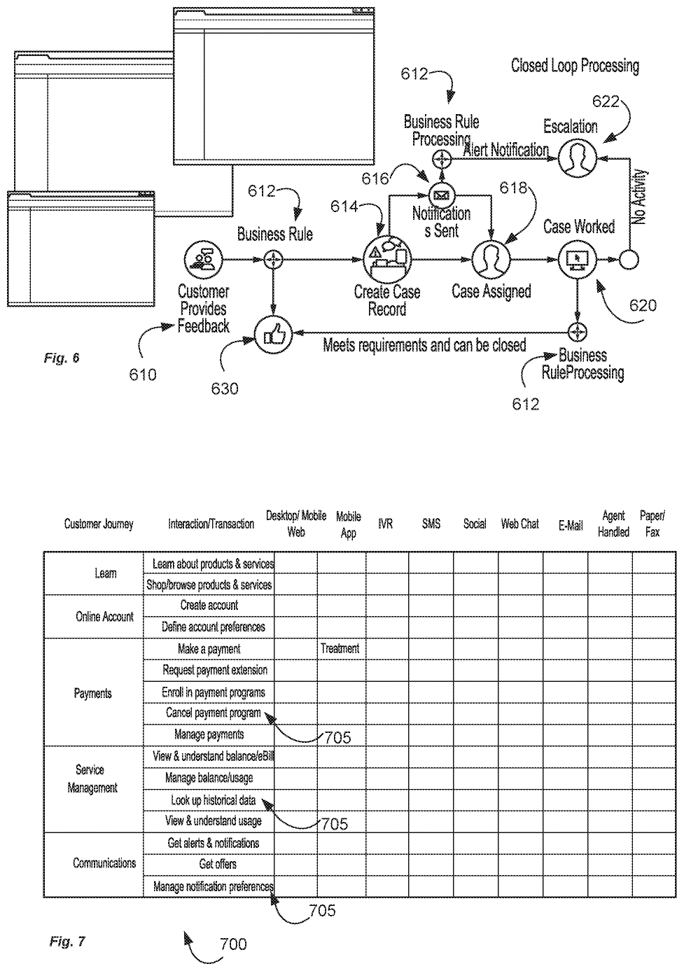

FIG. 7 is a diagram 700 illustrating an exemplary customer experience ecosystem and how the platform operates at facets 705 (i.e., where a customer's journey intersects a communications channel) within the ecosystem according to an embodiment of the subject matter disclosed herein. Such facets 705 may be associated with specific engagement and treatment paths as identified in the overall EOP.

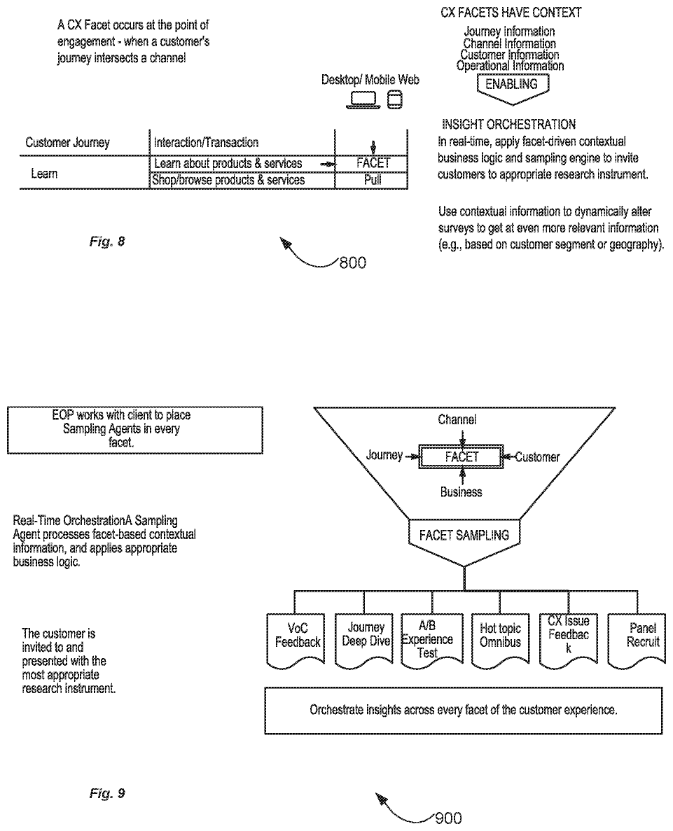

FIG. 8 is a diagram 800 illustrating customer experience facets within a customer experience ecosystem and how orchestration is applied at the facet level according to an embodiment of the subject matter disclosed herein. As illustrated in FIG. 8, customer experience facets i.e., where a customer's journey intersects a channel, have context such as journey information, channel information, customer specific information, and/or operational information. The EOP engagement orchestration system can apply facet driven contextual business logic to select the appropriate and relevant engagement instrument(s) to present to the customer at the proper time and through the proper channel. Furthermore, the platform can in some embodiments dynamically alter surveys to extract more relevant information, for example, based on customer segment or geography.

A comprehensive strategy for gathering insights (in near real time) across a subject organization's customer experience ecosystem provides data for an EOP orchestration engine to select the proper engagement instrument or instruments to deploy. Engagements applied across a subject organization's ecosystem involve probing operational client experience, operations, optimization, business experiments, innovation, exploratory, employees, customer perceptions, brand insights, plugged in panels. Various tools may be deployed for collecting insights including segmentation, key drivers, opportunity analysis, journey mapping, user research, communications/messaging, ideation & co-creation, feature & benefit optimization, and the like.

FIG. 9 is a diagram illustrating deployment of sampling agents within all or substantially all facets across the subject organization's ecosystem for the purpose of engagement orchestration according to an embodiment of the subject matter disclosed herein. With reference to FIG. 9, in some embodiments, sampling agents are deployed within all or substantially all facets across the subject organization's ecosystem. The sampling agent and orchestration engine processes the facet-based contextual information using appropriate business logic to select and present the most appropriate engagement instrument to the customer.

The subject matter described herein can be implemented in software in combination with hardware and/or firmware. For example, the subject matter described herein may be implemented in software executed by one or more processors. In one exemplary implementation, the subject matter described herein may be implemented using a non-transitory computer readable medium having stored thereon computer executable instructions that when executed by the processor of a computer control the computer to perform steps. Exemplary computer readable media suitable for implementing the subject matter described herein include non-transitory computer readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

The system may use a bus that can be any of several types of suitable bus structure(s) including the memory bus or memory controller, a peripheral bus or external bus, and/or a local bus using any suitable variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The systems and methods herein enable rapid ingestion of big data sets in a distributed computing environment. The metadata driven approach intake processing reduces source ingestion time, enhances reliability, and automates data intake. Furthermore, the platform agnostic nature of the present disclosure can operate on an input source in any electronic format. The error logging and reporting of the present disclosure further enable users to monitor progress and identify bad data based on predetermined or dynamically generated validation tolerances.

As used herein, “match” or “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Any communication, transmission and/or channel discussed herein may include any system or method for delivering content (e.g., data, information, metadata, and the like), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE®TV®, PANDORA®, XBOX®, SONY® PLAYSTATION®), a uniform resource locator (“URL”), a document (e.g., a MICROSOFT® Word® document, a MICROSOFT® Excel® document, an ADOBE® .pdf document, and the like), an “eBook,” an “emagazine,” an application or microapplication (as described herein), an SMS or other type of text message, an email, facebook, twitter, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website, a social media site, affiliate or partner websites, an external vendor, and a mobile device communication. Examples of social media sites include FACEBOOK®, FOURSQUARE®, TWITTER®, MYSPACE®, LINKEDIN®, and the like. Examples of affiliate or partner websites include AMERICAN EXPRESS®, GROUPON®, LIVINGSOCIAL®, and the like. Moreover, examples of mobile device communications include texting, email, and mobile applications for smartphones.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS® NT®, WINDOWS® 95/98/2000®, WINDOWS® XP®, WINDOWS® Vista®, WINDOWS® 7®, OS2, UNIX®, LINUX®, SOLARIS®, MacOS, and the like) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

Computer system also includes a main memory, such as for example random access memory (RAM), and may also include a secondary memory. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

Computer system may also include a communications interface. Communications interface allows software and data to be transferred between computer system and external devices. Examples of communications interface may include a modem, a network interface (such as an Ethernet account), a communications port, a Personal Computer Memory Account International Association (PCMCIA) slot and account, and the like. Software and data transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular 30 link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

Any databases discussed herein may include relational, hierarchical, graphical, or object-oriented structure and/or any other database configurations. Common database products that may be used to implement the databases include DB2 by IBM® (Armonk, N.Y.), various database products available from ORACLE® Corporation (Redwood Shores, Calif.), MICROSOFT® Access® or MICROSOFT® SQL Server® by MICROSOFT® Corporation (Redmond, Wash.), MySQL by MySQL AB (Uppsala, Sweden), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® NT web server software, a MICROSOFT® SQL Server database system, and a MICROSOFT® Commerce Server. Additionally, components such as Access or MICROSOFT® SQL Server, ORACLE®, Sybase, Informix MySQL, Interbase, and the like, may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® APPLE®, JAVASCRIPT, active server pages (ASP) common gateway interface scripts (CGI), extensible markup language (XML), dynamic HTML, cascading style sheets (CSS), AJAX (Asynchronous JAVASCRIPT and XML), helper applications, plug-ins, and the like. A server may include a web service that receives a request from a web server, the request including a URL and an IP address (123.56.789.234). The web server retrieves the appropriate web pages and sends the data or applications for the web pages to the IP address. Web services are applications that are capable of interacting with other applications over a communication means, such as the internet. Web services are typically based on standards or protocols such as XML, SOAP, AJAX, WSDL and UDDI. Web services methods are well known in the art and are covered in many standard texts. See, e.g., ALEX NGHIEM, IT WEB SERVICES: A ROADMAP FOR THE ENTERPRISE (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE MQ™ (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet-based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method are described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general-purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of process flow and the descriptions thereof may make reference to user WINDOWS®, webpages, websites, web forms, prompts, and the like. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Phrases and terms similar to “internal data” may include any data a credit issuer possesses or acquires pertaining to a particular consumer. Internal data may be gathered before, during, or after a relationship between the credit issuer and the transaction account holder (e.g., the consumer or buyer). Such data may include consumer demographic data. Consumer demographic data includes any data pertaining to a consumer. Consumer demographic data may include consumer name, address, telephone number, email address, employer and social security number. Consumer transactional data is any data pertaining to the particular transactions in which a consumer engages during any given time period. Consumer transactional data may include, for example, transaction amount, transaction time, transaction vendor/merchant, and transaction vendor/merchant location.

Systems, methods and computer program products are provided. In the detailed description herein, references to “various embodiments”, “one embodiment”, “an embodiment”, “an example embodiment”, and the like, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to cat least one of A, B, and C′ or cat least one of A, B, or C′ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” are used in either the detailed description or the claims, such terms are intended to be inclusive in a manner similar to the term “comprising” as “comprising” is interpreted when employed as a transitional word in a claim.

Since many modifications, variations, and changes in detail can be made to the described preferred embodiments of the subject matter, it is intended that all matters in the foregoing description and shown in the accompanying drawings be interpreted as illustrative and not in a limiting sense. Thus, the scope of the subject matter should be determined by the appended claims and their legal equivalence.

What is claimed is:

1. A computer-implemented method, comprising:
in an engagement orchestration platform, establishing a plurality of engagement instruments configured to engage one or more customers, the engagement instruments persisted in an engagement database;
establishing a plurality of treatment instruments configured to present data to a customer, the treatment instruments persisted in a treatment database;
identifying a customer in need of an engagement and treatment instrument combination;
assigning a priority rating to each combination of engagement and treatment instruments persisted in the engagement and treatment databases, the priority rating assigned in response to a function of a) a context associated with the identified customer, b) a treatment instrument hit rate, c) an engagement instrument cooperation rate, and d) an engagement instrument fitness score; and
dynamically selecting one combination of treatment and engagement instruments having the highest priority rating to be presented to the identified customer.

2. The method of claim 1, wherein the function corresponding to assigning a priority rating to each combination of engagement and treatment instruments further comprises a product of a) the treatment instrument hit rate, b) an engagement instrument cooperation rate, and c) the engagement instrument fitness score.

3. The method of claim 1, wherein providing for assignment of priorities to combinations of engagement instruments and treatment instruments includes providing a configurable data entry user interface for entering the priorities assigned to the combinations.

4. The method of claim 1, wherein providing for assignment of priorities to treatment instruments includes providing a configurable data entry user interface for entering the priorities assigned each treatment instrument.

5. The method of claim 1, wherein the engagement fitness score comprises a function of a contextually relevant treatment click rate across impressions for contextually similar individuals presented with the treatment and a contextually relevant engagement instrument cooperation rate for contextually similar individuals presented with the engagement instrument.

6. The method of claim 1 wherein the engagement instrument presented to identified customer comprises one of the group including: feedback instruments, invitations to in-depth interviews, recruitment to services, coupons, advertisements, and an electronic communication having an offer to participate in contextually relevant engagements.

7. The method of claim 1, wherein the treatment instrument hit rate comprises an historical accounting of a rate of interaction when a treatment is deployed.

8. The method of claim 1, wherein the engagement instrument cooperation rate comprises an historical accounting of a rate of engagement when is said engagement is deployed.

9. The method of claim 1, wherein the function corresponding to assigning a priority rating to each combination of engagement and treatment instruments further comprises a greater weighting for the treatment hit rate with respect to the engagement instrument cooperation rate and the engagement instrument fitness score.

10. The method of claim 1, wherein the function corresponding to assigning a priority rating to each combination of engagement and treatment instruments further comprises a greater weighting for the engagement instrument cooperation rate with respect to treatment hit rate and the engagement instrument fitness score.

11. The method of claim 1, wherein the function corresponding to assigning a priority rating to each combination of engagement and treatment instruments further comprises a greater weighting for the engagement instrument fitness score with respect to the treatment hit rate and the engagement instrument cooperation rate.

12. A computing platform, comprising:
at least one processor;
a first database configured to store a plurality of treatment configurations;
a second database configured to store a plurality of engagement instrument configurations;
a third database configured to store business requirements corresponding respectively with a plurality of user organizations;
an analysis engine coupled to the processor and each of the first, second, and third databases and configured to generate, with respect to a context associated with an identified customer, treatment instrument hit rates for each treatment in the first database, engagement instrument cooperation rates for each engagement instrument in the second database, and engagement instrument fitness scores corresponding to a user organization for each engagement instrument in the second database; and
an engagement orchestration engine coupled to the processor and each of the first, second and third databases and configured to generate a respective priority rating that is assigned to each combination of engagement instrument and treatment instrument as a function of the treatment instrument hit rate, the engagement instrument cooperation rate, and the engagement instrument fitness score.

13. The computing platform of claim 12, further comprising an interface module configured to present interfaces for collecting data from a user wherein the interface comprises a configurable data entry user interface for collecting business objective data from said user.

14. The computing platform of claim 12, wherein the function corresponding to assigning a priority rating to each engagement instrument further comprises a product of the treatment instrument hit rate, an engagement instrument cooperation rate, and c) the engagement instrument fitness score.

15. The computing platform of claim 12, wherein the engagement fitness score comprises a function of a contextually relevant treatment click rate across impressions for contextually similar individuals presented with the treatment and a contextually relevant engagement instrument cooperation rate for contextually similar individuals presented with the engagement instrument.

16. The computing platform of claim 12, wherein the engagement instrument presented to the identified customer comprises one of the group including: feedback instruments, invitations to in-depth interviews, recruitment to services, coupons, advertisements, and an electronic communication having an offer to participate in contextually relevant engagements.

17. The computing platform of claim 12, wherein the treatment instrument hit rate comprises an historical accounting of a rate of interaction when a treatment is deployed.

18. The computing platform of claim 12, wherein the engagement instrument cooperation rate comprises an historical accounting of a rate of engagement when is said engagement is deployed.

19. A non-transitory computer-readable medium having stored thereon executable instructions that when executed by a processor cause the processor to perform steps comprising:
establishing a plurality of engagement instruments configured to engage one or more customers, the engagement instruments persisted in an engagement database;
establishing a plurality of treatment instruments configured to present data to a customer, the treatment instruments persisted in a treatment database;
identifying a customer in need of an engagement and treatment instrument combination;
assigning a priority rating to each combination of engagement and treatment instruments persisted in the engagement and treatment databases, the priority rating assigned in response to a function of a) a context associated with the identified customer, b) a treatment instrument hit rate, c) an engagement instrument cooperation rate, and d) an engagement instrument fitness score; and
dynamically selecting one combination of treatment and engagement instruments having the highest priority rating to be presented to the identified customer; and
presenting the selected combination of treatment and engagement instruments to a customer.

20. The computer-readable medium of claim 19, wherein the function corresponding to assigning a priority rating to each combination of engagement and treatment instruments further comprises a product of a) the treatment instrument hit rate, b) an engagement instrument cooperation rate, and c) the engagement instrument fitness score.
